(19) United States
(12) Patent Application Publication
(10) Pub. No.: US 2024/0021917 A1
(43) Pub. Date: Jan. 18, 2024

(54) FIRE-SPREADING PREVENTION BATTERY MODULE

(71) Applicant: Cheng Uei Precision Industry Co., LTD., New Taipei City (TW)

(72) Inventors: JEN-KAI HUANG, New Taipei City (TW); PING-YU LEE, New Taipei City (TW); HSU-LUN HSU, New Taipei City (TW); SSU-YING CHEN, New Taipei City (TW); TA-CHANG YANG, New Taipei City (TW); MIN-YU WU, New Taipei City (TW); MING-CHIA CHI, New Taipei City (TW)

(21) Appl. No.: 18/135,181

(22) Filed: Apr. 16, 2023

(30) Foreign Application Priority Data
Jul. 15, 2022 (CN) 202221818508.9

(51) Int. Cl. H01M 10/658; H01M 50/213; H01M 50/291; A62C 3/16

(52) U.S. Cl. CPC H01M 10/658; H01M 50/213; H01M 50/291; A62C 3/16; H01M 2200/20

(57) ABSTRACT

A fire-spreading prevention battery module includes a plurality of battery cells, a plurality of fire-spreading prevention pads, an upper battery frame, a plurality of upper electrode plates, a lower battery frame, a plurality of first lower electrode plates and two second lower electrode plates. Each battery cell is formed in a cylinder shape. Each fire-spreading prevention pad wraps a peripheral surface of one battery cell. The plurality of the upper electrode plates are mounted on an upper surface of the upper battery frame. The plurality of the first lower electrode plates are mounted to a middle of a lower surface of the lower battery frame. The two second lower electrode plates are mounted to two ends of the lower surface of the lower battery frame. The plurality of the first lower electrode plates are arranged between the two second lower electrode plates.

### CROSS-REFERENCE TO RELATED APPLICATION

The present application is based on, and claims priority from, China Patent Application No. 202221818508.9, filed Jul. 15, 2022, the disclosure of which is hereby incorporated by reference herein in its entirety.

### BACKGROUND OF THE INVENTION

### 1. Field of the Invention

The present invention generally relates to a fire-spreading prevention battery module, and more particularly to a fire-spreading prevention battery module with a good fire-spreading prevention effect and an explosion-proof effect, and the fire-spreading prevention battery module having a heat dissipation effect and a heat homogeneity effect simultaneously.

### 2. The Related Art

Usually, a battery module has a high energy density, the battery modules are widely used in consumer electronic products and electric vehicles. When the battery modules are under conditions of high temperatures, short circuits, being squeezed or punctured, the battery modules are probable to cause thermal runaways to be on fire or explode. However, in general, the battery module is densely packed with multiple battery cells, if a single battery cell causes the thermal runaway, the thermal runaway of the single battery cell will be spread to the peripheral battery cells, so the battery cells also cause the thermal runaways, in a worse case, dangerous events are caused, fire is spread to an outside of the battery module, or explosive flames are spread to the outside of the battery module.

Therefore, it is necessary to provide a fire-spreading prevention battery module with a good fire-spreading prevention effect and an explosion-proof effect, and the fire-spreading prevention battery module having a heat dissipation effect and a heat homogeneity effect simultaneously to stop flames from spilling out to protect securities of a user and peripheral devices of the fire-spreading prevention battery module.

### SUMMARY OF THE INVENTION

An object of the present invention is to provide a fire-spreading prevention battery module with a good fire-spreading prevention effect and an explosion-proof effect, and the fire-spreading prevention battery module has a heat dissipation effect and a heat homogeneity effect simultaneously. The fire-spreading prevention battery module includes a plurality of battery cells, a plurality of fire-spreading prevention pads, an upper battery frame, a plurality of upper electrode plates, a lower battery frame, a plurality of first lower electrode plates and two second lower electrode plates. Each battery cell is formed in a cylinder shape. A top of each battery cell and a bottom of each battery cell are defined as a positive electrode and a negative electrode, respectively. Each fire-spreading prevention pad wraps a peripheral surface of one battery cell. The upper battery frame is formed in a band shape. The upper battery frame extends in a longitudinal direction. The upper battery frame has a plurality of upper slots vertically penetrating through the upper battery frame, a plurality of upper connection arms arranged among the plurality of the upper slots, and a plurality of upper limiting blocks arranged at upper edges of peripheral walls of the plurality of the upper slots. The plurality of the upper slots are arranged in two longitudinal rows. The plurality of the upper slots are arranged in a honeycomb pattern. The plurality of the upper electrode plates are mounted on an upper surface of the upper battery frame, and the plurality of the upper electrode plates cover the plurality of the upper slots. The lower battery frame is formed in the band shape. The lower battery frame extends in the longitudinal direction. The lower battery frame has a plurality of lower slots vertically penetrating through the lower battery frame, a plurality of lower connection arms arranged among the plurality of the lower slots, and a plurality of lower limiting blocks arranged at lower edges of peripheral walls of the plurality of the lower slots. The plurality of the lower slots are arranged in two longitudinal rows. The plurality of the lower slots are arranged in the honeycomb pattern. The plurality of the first lower electrode plates are mounted to a middle of a lower surface of the lower battery frame, and the plurality of the first lower electrode plates cover two middles of the two longitudinal rows of the lower slots. The two second lower electrode plates are mounted to two ends of the lower surface of the lower battery frame, and the two second lower electrode plates cover two ends of each longitudinal row of the lower slots. The two second lower electrode plates are arranged at the two opposite ends of the lower battery frame, and the plurality of the first lower electrode plates are arranged between the two second lower electrode plates.

Another object of the present invention is to provide a fire-spreading prevention battery module. The fire-spreading prevention battery module includes a plurality of battery cells, a plurality of fire-spreading prevention pads, an upper battery frame, a plurality of upper electrode plates, a lower battery frame, a plurality of first lower electrode plates and two second lower electrode plates. Each battery cell is formed in a cylinder shape. A top of each battery cell and a bottom of each battery cell are defined as a positive electrode and a negative electrode, respectively. Each fire-spreading prevention pad wraps a peripheral surface of one battery cell. Each fire-spreading prevention pad includes a gel layer, a plurality of flame-retardant material granules distributed in the gel layer, and an insulation film wrapping an outside of the gel layer. The upper battery frame is formed in a band shape. The upper battery frame extends in a longitudinal direction. The upper battery frame has a plurality of upper slots vertically penetrating through the upper battery frame, a plurality of upper connection arms arranged among the plurality of the upper slots, and a plurality of upper limiting blocks arranged at upper edges of peripheral walls of the plurality of the upper slots. The plurality of the upper slots are arranged in two longitudinal rows. The plurality of the upper slots are arranged in a honeycomb pattern. The plurality of the upper electrode plates are mounted on an upper surface of the upper battery frame, and the plurality of the upper electrode plates cover the plurality of the upper slots. The lower battery frame is formed in the band shape. The lower battery frame extends in the longitudinal direction. The lower battery frame has a plurality of lower slots vertically penetrating through the lower battery frame, a plurality of lower connection arms arranged among the plurality of the lower slots, and a plurality of lower limiting blocks arranged at lower edges of peripheral walls of the plurality of the lower slots. The plurality of the lower slots are arranged in two longitudinal rows. The plurality of the lower slots are arranged in the honeycomb pattern. The plurality of the first lower electrode plates are mounted to a middle of a lower surface of the lower battery frame, and the plurality of the first lower electrode plates cover two middles of the two longitudinal rows of the lower slots. The two second lower electrode plates are mounted to two ends of the lower surface of the lower battery frame, and the two second lower electrode plates cover two ends of each longitudinal row of the lower slots. The plurality of the first lower electrode plates are arranged between the two second lower electrode plates.

Another object of the present invention is to provide a fire-spreading prevention battery module. The fire-spreading prevention battery module includes a plurality of battery cells, a plurality of fire-spreading prevention pads, an upper battery frame, a plurality of upper electrode plates, a lower battery frame, a plurality of first lower electrode plates and two second lower electrode plates. Each battery cell is formed in a cylinder shape. A top of each battery cell and a bottom of each battery cell are defined as a positive electrode and a negative electrode, respectively. Each fire-spreading prevention pad wraps a peripheral surface of one battery cell. The upper battery frame is formed in a band shape. The upper battery frame extends in a longitudinal direction. The upper battery frame has a plurality of upper slots vertically penetrating through the upper battery frame, a plurality of upper connection arms arranged among the plurality of the upper slots, and a plurality of upper limiting blocks arranged at upper edges of peripheral walls of the plurality of the upper slots. The plurality of the upper slots are arranged in two longitudinal rows. The plurality of the upper slots are arranged in a honeycomb pattern. The plurality of the upper electrode plates are mounted on an upper surface of the upper battery frame, and the plurality of the upper electrode plates cover the plurality of the upper slots. Each upper electrode plate has an upper body extending in the longitudinal direction, and a plurality of upper terminal contacts protruded downward from the upper body. The upper body defines a plurality of upper pressure relieving holes. The plurality of the upper terminal contacts contact with the tops of the plurality of the battery cells. The plurality of the upper pressure relieving holes are disposed among the plurality of the upper terminal contacts. When internal pressures of the plurality of the battery cells are too high, the plurality of the upper pressure relieving holes release the pressures of the plurality of the battery cells. The lower battery frame is formed in the band shape. The lower battery frame extends in the longitudinal direction. The lower battery frame has a plurality of lower slots vertically penetrating through the lower battery frame, a plurality of lower connection arms arranged among the plurality of the lower slots, and a plurality of lower limiting blocks arranged at lower edges of peripheral walls of the plurality of the lower slots. The plurality of the lower slots are arranged in two longitudinal rows. The plurality of the lower slots are arranged in the honeycomb pattern. The plurality of the first lower electrode plates are mounted to a middle of a lower surface of the lower battery frame, and the plurality of the first lower electrode plates cover two middles of the two longitudinal rows of the lower slots. Each first lower electrode plate has a first lower body extending in the longitudinal direction, and a plurality of first lower terminal contacts protruded upward from the first lower body. The first lower body defines a plurality of first lower pressure relieving holes. The plurality of the first lower terminal contacts contact with the bottoms of the plurality of the battery cells. The plurality of the first lower pressure relieving holes are disposed among the plurality of the first lower terminal contacts. When internal pressures of the plurality of the battery cells are too high, the plurality of the first lower pressure relieving holes release the pressures of the plurality of the battery cells. The two second lower electrode plates are mounted to two ends of the lower surface of the lower battery frame, and the two second lower electrode plates cover two ends of each longitudinal row of the lower slots. The plurality of the first lower electrode plates are arranged between the two second lower electrode plates. Each second lower electrode plate has a second lower body extending in the longitudinal direction, and a plurality of second lower terminal contacts protruded upward from the second lower body. The second lower body defines a plurality of second lower pressure relieving holes. The plurality of the second lower terminal contacts contact with the bottoms of the plurality of the battery cells. The plurality of the second lower pressure relieving holes are disposed among the plurality of the second lower terminal contacts. When the internal pressures of the plurality of the battery cells are too high, the plurality of the second lower pressure relieving holes release the pressures of the plurality of the battery cells.

As described above, the fire-spreading prevention battery module includes the plurality of the battery cells, the plurality of the fire-spreading prevention pads wrapping the plurality of the battery cells, the upper battery frame which extends in the longitudinal direction and is provided with the plurality of the upper slots, the plurality of the upper electrode plates arranged on the upper surface of the upper battery frame, the lower battery frame which extends in the longitudinal direction and is provided with the plurality of the lower slots, the plurality of the first lower electrode plates mounted to the middle of the lower surface of the lower battery frame, and the two second lower electrode plates mounted to the two ends of the lower surface of the lower battery frame. The two second lower electrode plates are arranged at the two opposite ends of the lower battery frame, and the plurality of the first lower electrode plates are located between the two second lower electrode plates. As a result, the fire-spreading prevention battery module is with the good fire-spreading prevention effect and the explosion-proof effect, and the fire-spreading prevention battery module has the heat dissipation effect and the heat homogeneity effect simultaneously.

### BRIEF DESCRIPTION OF THE DRAWINGS

The present invention will be apparent to those skilled in the art by reading the following description, with reference to the attached drawings, in which:

FIG. 1 is a perspective view of a fire-spreading prevention battery module in accordance with a preferred embodiment of the present invention;

FIG. 2 is an exploded view of the fire-spreading prevention battery module in accordance with the preferred embodiment of the present invention;

FIG. 3 is an enlarged view of an encircled portion A of the fire-spreading prevention battery module of FIG. 2;

FIG. 4 is a perspective view of a lower battery frame of the fire-spreading prevention battery module of FIG. 2;

FIG. 5 is an enlarged view of an encircled portion V of the lower battery frame of the fire-spreading prevention battery module of FIG. 4; and

FIG. 6 is a sectional view of a fire-spreading prevention pad of the fire-spreading prevention battery module in accordance with the preferred embodiment of the present invention.

### DETAILED DESCRIPTION OF THE PREFERRED EMBODIMENT

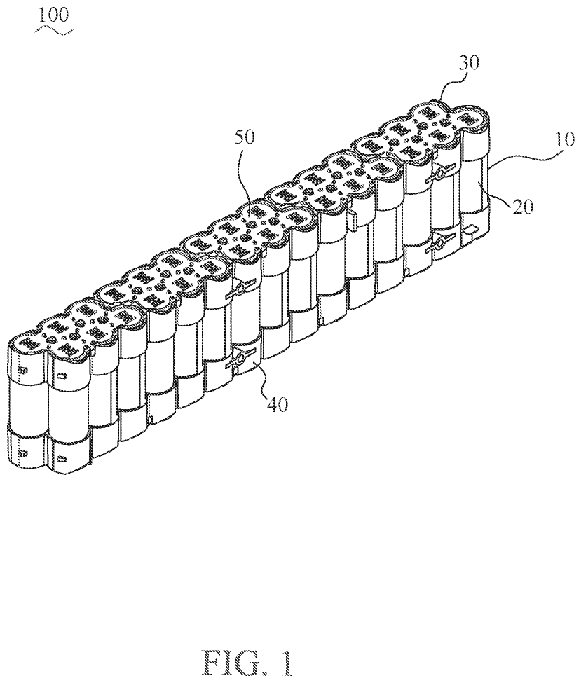

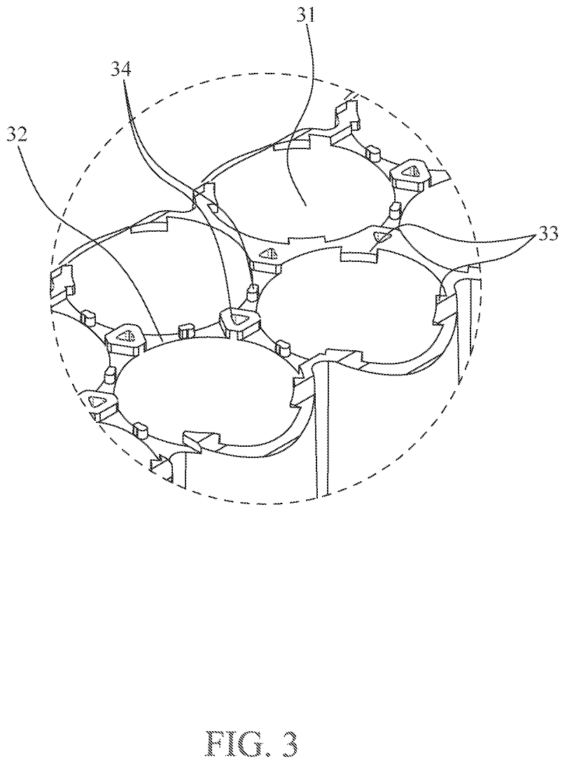

Referring to FIG. 1 to FIG. 3, a fire-spreading prevention battery module 100 in accordance with a preferred embodiment of the present invention is shown. The fire-spreading prevention battery module 100 includes a plurality of battery cells 10, a plurality of fire-spreading prevention pads 20, an upper battery frame 30, a lower battery frame 40, a plurality of upper electrode plates 50, a plurality of first lower electrode plates 60 and two second lower electrode plates 70.

Each battery cell 10 is formed in a cylinder shape. Each battery cell 10 is disposed vertically. A top of each battery cell 10 is a round shape seen from a top view. A bottom of each battery cell 10 is the round shape seen from a bottom view. The top of each battery cell 10 and the bottom of each battery cell 10 are defined as a positive electrode 11 and a negative electrode 12, respectively. Each fire-spreading prevention pad 20 wraps a peripheral surface of one battery cell 10.

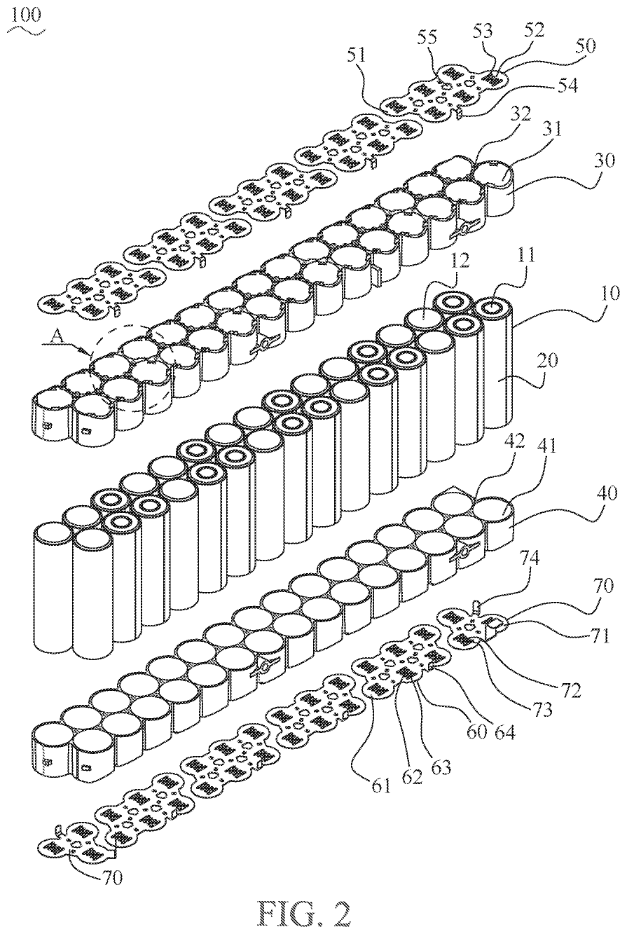

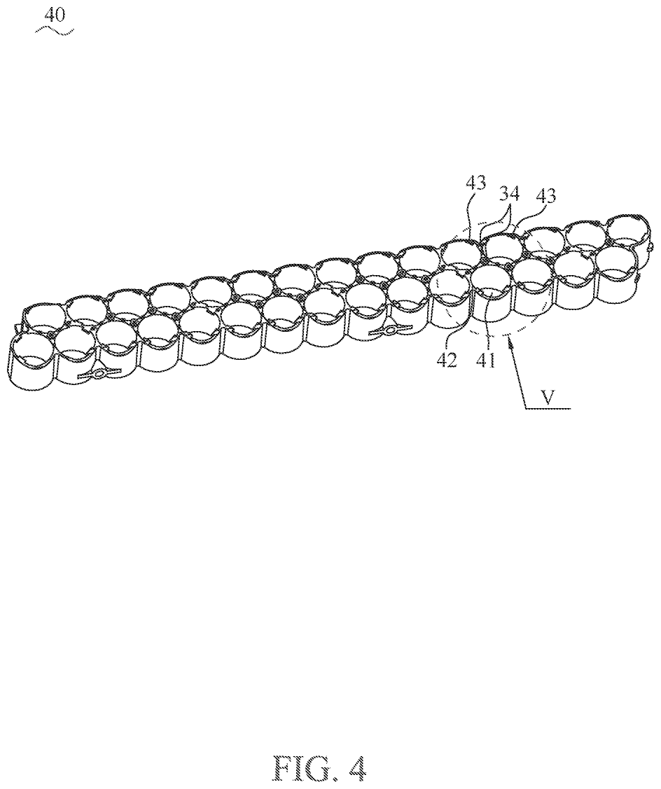

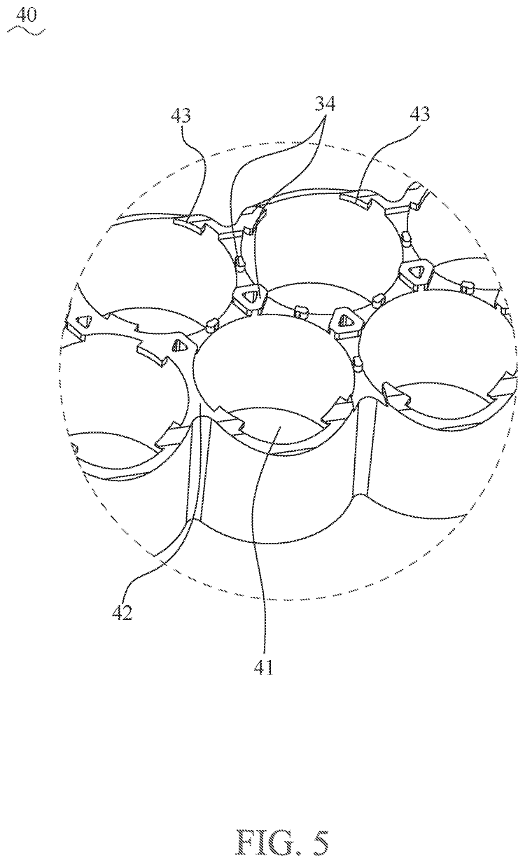

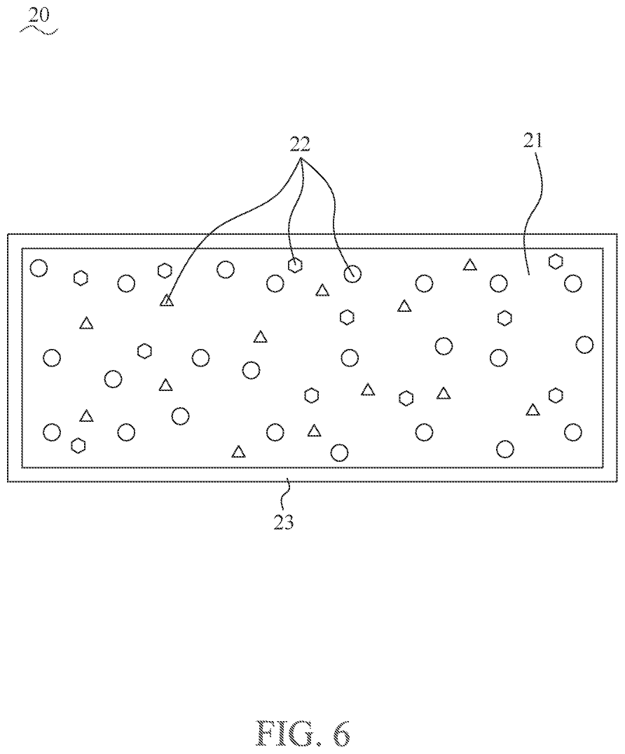

Referring to FIG. 2 to FIG. 6, in the preferred embodiment, the fire-spreading prevention battery module 100 includes thirty battery cells 10 and thirty fire-spreading prevention pads 20. Each fire-spreading prevention pad 20 includes a gel layer 21 which uses water as a main solvent, a plurality of flame-retardant material granules 22 distributed in the gel layer 21, and an insulation film 23 wrapping an outside of the gel layer 21. The insulation film 23 is a PE (Polyethylene) film. The insulation film 23 has a protection function for preventing the fire-spreading prevention battery module 100 mildewing or being damaged by ants. The flame-retardant material granules 22 are selected from materials which are magnesium hydroxides, aluminum hydroxides, zinc borates, glass sands, expanded graphites or a combination of the magnesium hydroxides, the aluminum hydroxides, the zinc borates, the glass sands and the expanded graphites. The flame-retardant material granules 22 are insoluble in the gel layer 21. The magnesium hydroxides and the aluminum hydroxides lower temperatures of the battery cells 10 of the fire-spreading prevention battery module 100. When the temperatures of the battery cells 10 of the fire-spreading prevention battery module 100 are overly high, the magnesium hydroxides and the aluminum hydroxides release water vapors. The zinc borates are used as adhesives and flame retardants. The glass sands are used as an isolating layer. The expanded graphites are used as another isolating layer, when the temperatures of the battery cells 10 of the fire-spreading prevention battery module 100 are overly high, the expanded graphites are expanded to obstruct a combustion space.

The flame-retardant material granules 22 which are in forms of suspended particles are distributed in the gel layer 21. When the flame-retardant material granules 22 are heated, volumes of the flame-retardant material granules 22 are expanded to form cavities in the gel layer 21 for isolating a fire source. In the preferred embodiment, the gel layer 21 is consisted of sugar, agar and the water. A main function of the sugar and the water of the gel layer 21 is a carrier, when the gel layer 21 is heated, carbon cokes are formed for isolating the fire source. A main function of the agar of the gel layer 21 is to make the sugar and the water solidified to solidify the flame-retardant material granules 22, so that a strength of each fire-spreading prevention pad 20 is enhanced.

The upper battery frame 30 is formed in a band shape seen from a vertical view. The upper battery frame 30 extends in a longitudinal direction. In the preferred embodiment, the upper battery frame 30 is a parallelogram shape. The upper battery frame 30 has a plurality of upper slots 31 vertically penetrating through the upper battery frame 30, a plurality of upper connection arms 32 arranged among the plurality of the upper slots 31, and a plurality of upper limiting blocks 33 arranged at upper edges of peripheral walls of the plurality of the upper slots 31. The plurality of the upper slots 31 are arranged in two longitudinal rows. The plurality of the upper slots 31 are arranged in a honeycomb pattern. In the preferred embodiment, a quantity of the upper slots 31 in each row is fifteen.

The plurality of the upper electrode plates 50 are mounted on an upper surface of the upper battery frame 30, and the plurality of the upper electrode plates 50 cover the plurality of the upper slots 31. In the preferred embodiment, each upper electrode plate 50 has an upper body 51 extending in the longitudinal direction, a plurality of upper terminal contacts 52, a plurality of upper pressure relieving holes 53 and an upper wire contact 54. The plurality of the upper terminal contacts 52 are protruded downward from the upper body 51. The upper body 51 defines the plurality of the upper pressure relieving holes 53. The plurality of the upper terminal contacts 52 contact with the tops of the plurality of the battery cells 10. The plurality of the upper terminal contacts 52 are arranged in two longitudinal rows. The plurality of the upper terminal contacts 52 are arranged in the honeycomb pattern.

Positions of the plurality of the upper terminal contacts 52 are cooperated with positions of the plurality of the upper slots 31. The plurality of the upper terminal contacts 52 are corresponding to the plurality of the upper slots 31. Each upper pressure relieving hole 53 is an I shape seen from the top view. Each upper pressure relieving hole 53 is disposed transversely. The plurality of the upper pressure relieving holes 53 are disposed among the plurality of the upper terminal contacts 52. When internal pressures of the plurality of the battery cells 10 are too high, the plurality of the upper pressure relieving holes 53 release the pressures of the plurality of the battery cells 10. The upper wire contact 54 is extended outward and then is extended downward from a lateral edge of the upper body 51.

A structure of the lower battery frame 40 is the same as a structure of the upper battery frame 30. The lower battery frame 40 and the upper battery frame 30 are assembled in two opposite directions. The lower battery frame 40 is formed in the band shape seen from the vertical view. The lower battery frame 40 is the parallelogram shape. The lower battery frame 40 extends in the longitudinal direction. The lower battery frame 40 has a plurality of lower slots 41 vertically penetrating through the lower battery frame 40, and a plurality of lower connection arms 42. The plurality of the lower slots 41 are arranged in two longitudinal rows. The plurality of the lower slots 41 are arranged in the honeycomb pattern. In the preferred embodiment, a quantity of each longitudinal row of the lower slots 41 is fifteen. The plurality of the lower connection arms 42 are arranged among the plurality of the lower slots 41. The lower battery frame 40 further has a plurality of lower limiting blocks 43 arranged at lower edges of peripheral walls of the plurality of the lower slots 41.

The plurality of the first lower electrode plates 60 are mounted to a middle of a lower surface of the lower battery frame 40, and the plurality of the first lower electrode plates 60 cover two middles of the two longitudinal rows of the lower slots 41. In the preferred embodiment, the fire-spreading prevention battery module 100 includes four first lower electrode plates 60. Each first lower electrode plate 60 has a first lower body 61 extending in the longitudinal direction, a plurality of first lower terminal contacts 62, a plurality of first lower pressure relieving holes 63 and a first lower wire contact 64. The plurality of the first lower terminal contacts 62 are protruded upward from the first lower body 61. The first lower body 61 defines the plurality of the first lower pressure relieving holes 63. The plurality of the first lower terminal contacts 62 contact with the bottoms of the plurality of the battery cells 10. The plurality of the first lower terminal contacts 62 are arranged in two longitudinal rows. The plurality of the first lower terminal contacts 62 are arranged in the honeycomb pattern.

Positions of the plurality of the first lower terminal contacts 62 are cooperated with positions of the plurality of the lower slots 41. The plurality of the first lower terminal contacts 62 are corresponding to the plurality of the lower slots 41. Each first lower pressure relieving hole 63 is the I shape seen from the bottom view. Each first lower pressure relieving hole 63 is disposed transversely. The plurality of the first lower pressure relieving holes 63 are disposed among the plurality of the first lower terminal contacts 62. When the internal pressures of the plurality of the battery cells 10 are too high, the plurality of the first lower pressure relieving holes 63 release the pressures of the plurality of the battery cells 10. The first lower wire contact 64 is extended outward and then is extended upward from a lateral edge of the first lower body 61.

The two second lower electrode plates 70 are mounted to two ends of the lower surface of the lower battery frame 40, and the two second lower electrode plates cover two ends of each longitudinal row of the lower slots 41. The plurality of the first lower electrode plates 60 are located between the two second lower electrode plates Each second lower electrode plate 70 has a second lower body 71 extending in the longitudinal direction, a plurality of second lower terminal contacts 72, a plurality of second lower pressure relieving holes 73 and a second lower wire contact 74. The plurality of the second lower terminal contacts 72 are protruded upward from the second lower body 71. The second lower body 71 defines the plurality of the second lower pressure relieving holes 73. The plurality of the second lower terminal contacts 72 contact with the bottoms of the plurality of the battery cells 10. The plurality of the second lower terminal contacts 72 are arranged in two longitudinal rows. The two longitudinal rows of the second lower terminal contacts 72 are aligned with the two longitudinal rows of the first lower terminal contacts 62. The plurality of the second lower terminal contacts 72 are arranged in the honeycomb pattern.

Positions of the plurality of the second lower terminal contacts 72 are cooperated with positions of the plurality of the lower slots 41. The plurality of the second lower terminal contacts 72 are corresponding to the plurality of the lower slots 41. Each second lower pressure relieving hole 73 is the I shape seen from the bottom view. Each second lower pressure relieving hole 73 is disposed transversely. The plurality of the second lower pressure relieving holes 73 are disposed among the plurality of the second lower terminal contacts 72. When the internal pressures of the plurality of the battery cells 10 are too high, the plurality of the second lower pressure relieving holes 73 release the pressures of the plurality of the battery cells 10. The second lower wire contact 74 is extended outward, then is extended upward and is further extended outward from a lateral edge of the second lower body 71. A quantity of the second lower terminal contacts 72 of each second lower body 71 is half of a quantity of the first lower terminal contacts 62 of each first lower body 61. A quantity of the second lower pressure relieving holes 73 of each second lower body 71 is half of a quantity of the first lower pressure relieving holes 63 of each first lower body 61.

The two second lower electrode plates 70 are arranged at two opposite ends of the lower battery frame 40, and the plurality of the first lower electrode plates 60 are arranged between the two second lower electrode plates 70. Each three battery cells 10 form a group of the battery cells 10. Polarities of each group of the battery cells 10 are the same. Polarities of the tops of each two adjacent groups of the battery cells 10 are different. Polarities of the bottoms of each two adjacent groups of the battery cells 10 are different. Positive polarities and negative polarities of the tops of all the groups of the battery cells 10 are alternatively disposed between the upper battery frame 30 and the lower battery frame 40. Positive polarities and negative polarities of the bottoms of all the groups of the battery cells 10 are alternatively disposed between the upper battery frame 30 and the lower battery frame 40, so that each group of the battery cells 10 are electrically connected in series.

Referring to FIG. 1 to FIG. 5, in this preferred embodiment, top surfaces of the plurality of the upper connection arms 32 of the upper battery frame 30 and the lower connection arms 42 of the lower battery frame 40 has a plurality of positioning bumps 34. The plurality of the upper electrode plates 50, the plurality of the first lower electrode plates 60 and the two second lower electrode plates 70 define a plurality of positioning holes 55 matched with the plurality of the positioning bumps 34. The plurality of the positioning bumps 34 are embedded in the plurality of the positioning holes 55.

As described above, the fire-spreading prevention battery module 100 includes the plurality of the battery cells 10, the plurality of the fire-spreading prevention pads 20 wrapping the plurality of the battery cells 10, the upper battery frame 30 which extends in the longitudinal direction and is provided with the plurality of the upper slots 31, the plurality of the upper electrode plates 50 arranged on the upper surface of the upper battery frame 30, the lower battery frame 40 which extends in the longitudinal direction and is provided with the plurality of the lower slots 41, the plurality of the first lower electrode plates 60 mounted to the middle of the lower surface of the lower battery frame 40, and the two second lower electrode plates 70 mounted to the two ends of the lower surface of the lower battery frame 40. The two second lower electrode plates 70 are arranged at the two opposite ends of the lower battery frame 40, and the plurality of the first lower electrode plates 60 are located between the two second lower electrode plates 70. As a result, the fire-spreading prevention battery module 100 is with the good fire-spreading prevention effect and the explosion-proof effect, and the fire-spreading prevention battery module 100 has a heat dissipation effect and a heat homogeneity effect simultaneously.

What is claimed is:

1. A fire-spreading prevention battery module, comprising:
a plurality of battery cells, each battery cell being formed in a cylinder shape, a top of each battery cell and a bottom of each battery cell being defined as a positive electrode and a negative electrode, respectively;
a plurality of fire-spreading prevention pads, each fire-spreading prevention pad wrapping a peripheral surface of one battery cell;
an upper battery frame formed in a band shape, the upper battery frame extending in a longitudinal direction, the upper battery frame having a plurality of upper slots vertically penetrating through the upper battery frame, a plurality of upper connection arms arranged among the plurality of the upper slots, and a plurality of upper limiting blocks arranged at upper edges of peripheral walls of the plurality of the upper slots, the plurality of the upper slots being arranged in two longitudinal rows, the plurality of the upper slots being arranged in a honeycomb pattern;
a plurality of upper electrode plates mounted on an upper surface of the upper battery frame, and the plurality of the upper electrode plates covering the plurality of the upper slots;
a lower battery frame formed in the band shape, the lower battery frame extending in the longitudinal direction, the lower battery frame having a plurality of lower slots vertically penetrating through the lower battery frame, a plurality of lower connection arms arranged among the plurality of the lower slots, and a plurality of lower limiting blocks arranged at lower edges of peripheral walls of the plurality of the lower slots, the plurality of the lower slots being arranged in two longitudinal rows, the plurality of the lower slots being arranged in the honeycomb pattern;
a plurality of first lower electrode plates mounted to a middle of a lower surface of the lower battery frame, and the plurality of the first lower electrode plates covering two middles of the two longitudinal rows of the lower slots; and
two second lower electrode plates mounted to two ends of the lower surface of the lower battery frame, and the two second lower electrode plates covering two ends of each longitudinal row of the lower slots;
wherein the two second lower electrode plates are arranged at the two opposite ends of the lower battery frame, and the plurality of the first lower electrode plates are arranged between the two second lower electrode plates.

2. The fire-spreading prevention battery module as claimed in claim 1, wherein each fire-spreading prevention pad includes a gel layer which uses water as a main solvent, a plurality of flame-retardant material granules distributed in the gel layer, and an insulation film wrapping an outside of the gel layer.

3. The fire-spreading prevention battery module as claimed in claim 2, wherein the gel layer is consisted of sugar, agar and water.

4. The fire-spreading prevention battery module as claimed in claim 2, wherein the flame-retardant material granules are selected from materials which are magnesium hydroxides, aluminum hydroxides, zinc borates, glass sands, expanded graphites or a combination of the magnesium hydroxides, the aluminum hydroxides, the zinc borates, the glass sands and the expanded graphites.

5. The fire-spreading prevention battery module as claimed in claim 2, wherein the insulation film plays a protection function.

6. The fire-spreading prevention battery module as claimed in claim 1, wherein each upper electrode plate has an upper body extending in the longitudinal direction, a plurality of upper terminal contacts protruded downward from the upper body, and an upper wire contact, the upper body defines a plurality of upper pressure relieving holes, the plurality of the upper terminal contacts contact with the tops of the plurality of the battery cells, the plurality of the upper terminal contacts are arranged in two longitudinal rows, the plurality of the upper terminal contacts are arranged in the honeycomb pattern, positions of the plurality of the upper terminal contacts are cooperated with positions of the plurality of the upper slots, the plurality of the upper pressure relieving holes are disposed among the plurality of the upper terminal contacts, when internal pressures of the plurality of the battery cells are too high, the plurality of the upper pressure relieving holes release the pressures of the plurality of the battery cells, the upper wire contact is extended outward and then is extended downward from a lateral edge of the upper body.

7. The fire-spreading prevention battery module as claimed in claim 6, wherein each upper pressure relieving hole is an I shape, each upper pressure relieving hole is disposed transversely.

8. The fire-spreading prevention battery module as claimed in claim 1, wherein each first lower electrode plate has a first lower body extending in the longitudinal direction, a plurality of first lower terminal contacts protruded upward from the first lower body, and a first lower wire contact, the first lower body defines a plurality of first lower pressure relieving holes, the plurality of the first lower terminal contacts contact with the bottoms of the plurality of the battery cells, the plurality of the first lower terminal contacts are arranged in two longitudinal rows, the plurality of the first lower terminal contacts are arranged in the honeycomb pattern, positions of the plurality of the first lower terminal contacts are cooperated with positions of the plurality of the lower slots, the plurality of the first lower pressure relieving holes are disposed among the plurality of the first lower terminal contacts, when internal pressures of the plurality of the battery cells are too high, the plurality of the first lower pressure relieving holes release the pressures of the plurality of the battery cells, the first lower wire contact is extended outward and then is extended upward from a lateral edge of the first lower body.

9. The fire-spreading prevention battery module as claimed in claim 8, wherein each first lower pressure relieving hole is an I shape, each first lower pressure relieving hole is disposed transversely.

10. The fire-spreading prevention battery module as claimed in claim 8, wherein each second lower electrode plate has a second lower body extending in the longitudinal direction, a plurality of second lower terminal contacts protruded upward from the second lower body, and a second lower wire contact, the second lower body defines a plurality of second lower pressure relieving holes, the plurality of the second lower terminal contacts contact with the bottoms of the plurality of the battery cells, the plurality of the second lower terminal contacts are arranged in two longitudinal rows, the two longitudinal rows of the second lower terminal contacts are aligned with the two longitudinal rows of the first lower terminal contacts, the plurality of the second lower terminal contacts are arranged in the honeycomb pattern, positions of the plurality of the second lower terminal contacts are cooperated with positions of the plurality of the lower slots, the plurality of the second lower pressure relieving holes are disposed among the plurality of the second lower terminal contacts, when the internal pressures of the plurality of the battery cells are too high, the plurality of the second lower pressure relieving holes release the pressures of the plurality of the battery cells, the second lower wire contact is extended outward, then is extended upward and is further extended outward from a lateral edge of the second lower body.

11. The fire-spreading prevention battery module as claimed in claim 10, wherein a quantity of the second lower terminal contacts of each second lower body is half of a quantity of the first lower terminal contacts of each first lower body, a quantity of the second lower pressure relieving holes of each second lower body is half of a quantity of the first lower pressure relieving holes of each first lower body.

12. The fire-spreading prevention battery module as claimed in claim 10, wherein each second lower pressure relieving hole is an I shape, each second lower pressure relieving hole is disposed transversely.

13. The fire-spreading prevention battery module as claimed in claim 1, wherein top surfaces of the plurality of the upper connection arms of the upper battery frame and the lower connection arms of the lower battery frame has a plurality of positioning bumps, the plurality of the upper electrode plates, the plurality of the first lower electrode plates and the two second lower electrode plates define a plurality of positioning holes matched with the plurality of the positioning bumps, the plurality of the positioning bumps are embedded in the plurality of the positioning holes.

14. A fire-spreading prevention battery module, comprising:
a plurality of battery cells, each battery cell being formed in a cylinder shape, a top of each battery cell and a bottom of each battery cell being defined as a positive electrode and a negative electrode, respectively;
a plurality of fire-spreading prevention pads, each fire-spreading prevention pad wrapping a peripheral surface of one battery cell, each fire-spreading prevention pad including a gel layer, a plurality of flame-retardant material granules distributed in the gel layer, and an insulation film wrapping an outside of the gel layer;
an upper battery frame formed in a band shape, the upper battery frame extending in a longitudinal direction, the upper battery frame having a plurality of upper slots vertically penetrating through the upper battery frame, a plurality of upper connection arms arranged among the plurality of the upper slots, and a plurality of upper limiting blocks arranged at upper edges of peripheral walls of the plurality of the upper slots, the plurality of the upper slots being arranged in two longitudinal rows, the plurality of the upper slots being arranged in a honeycomb pattern;
a plurality of upper electrode plates mounted on an upper surface of the upper battery frame, and the plurality of the upper electrode plates covering the plurality of the upper slots;
a lower battery frame formed in the band shape, the lower battery frame extending in the longitudinal direction, the lower battery frame having a plurality of lower slots vertically penetrating through the lower battery frame, a plurality of lower connection arms arranged among the plurality of the lower slots, and a plurality of lower limiting blocks arranged at lower edges of peripheral walls of the plurality of the lower slots, the plurality of the lower slots being arranged in two longitudinal rows, the plurality of the lower slots being arranged in the honeycomb pattern;
a plurality of first lower electrode plates mounted to a middle of a lower surface of the lower battery frame, and the plurality of the first lower electrode plates covering two middles of the two longitudinal rows of the lower slots; and
two second lower electrode plates mounted to two ends of the lower surface of the lower battery frame, and the two second lower electrode plates covering two ends of each longitudinal row of the lower slots, the plurality of the first lower electrode plates being arranged between the two second lower electrode plates.

15. A fire-spreading prevention battery module, comprising:
a plurality of battery cells, each battery cell being formed in a cylinder shape, a top of each battery cell and a bottom of each battery cell being defined as a positive electrode and a negative electrode, respectively;
a plurality of fire-spreading prevention pads, each fire-spreading prevention pad wrapping a peripheral surface of one battery cell;
an upper battery frame formed in a band shape, the upper battery frame extending in a longitudinal direction, the upper battery frame having a plurality of upper slots vertically penetrating through the upper battery frame, a plurality of upper connection arms arranged among the plurality of the upper slots, and a plurality of upper limiting blocks arranged at upper edges of peripheral walls of the plurality of the upper slots, the plurality of the upper slots being arranged in two longitudinal rows, the plurality of the upper slots being arranged in a honeycomb pattern;
a plurality of upper electrode plates mounted on an upper surface of the upper battery frame, and the plurality of the upper electrode plates covering the plurality of the upper slots, each upper electrode plate having an upper body extending in the longitudinal direction, and a plurality of upper terminal contacts protruded downward from the upper body, the upper body defining a plurality of upper pressure relieving holes, the plurality of the upper terminal contacts contacting with the tops of the plurality of the battery cells, the plurality of the upper pressure relieving holes being disposed among the plurality of the upper terminal contacts, when internal pressures of the plurality of the battery cells are too high, the plurality of the upper pressure relieving holes releasing the pressures of the plurality of the battery cells;
a lower battery frame formed in the band shape, the lower battery frame extending in the longitudinal direction, the lower battery frame having a plurality of lower slots vertically penetrating through the lower battery frame, a plurality of lower connection arms arranged among the plurality of the lower slots, and a plurality of lower limiting blocks arranged at lower edges of peripheral walls of the plurality of the lower slots, the plurality of the lower slots being arranged in two longitudinal rows, the plurality of the lower slots being arranged in the honeycomb pattern;
a plurality of first lower electrode plates mounted to a middle of a lower surface of the lower battery frame, and the plurality of the first lower electrode plates covering two middles of the two longitudinal rows of the lower slots, each first lower electrode plate having a first lower body extending in the longitudinal direction, and a plurality of first lower terminal contacts protruded upward from the first lower body, the first lower body defining a plurality of first lower pressure relieving holes, the plurality of the first lower terminal contacts contacting with the bottoms of the plurality of the battery cells, the plurality of the first lower pressure relieving holes being disposed among the plurality of the first lower terminal contacts, when internal pressures of the plurality of the battery cells are too high, the plurality of the first lower pressure relieving holes releasing the pressures of the plurality of the battery cells; and
two second lower electrode plates mounted to two ends of the lower surface of the lower battery frame, and the two second lower electrode plates covering two ends of each longitudinal row of the lower slots, the plurality of the first lower electrode plates being arranged between the two second lower electrode plates, each second lower electrode plate having a second lower body extending in the longitudinal direction, and a plurality of second lower terminal contacts protruded upward from the second lower body, the second lower body defining a plurality of second lower pressure relieving holes, the plurality of the second lower terminal contacts contacting with the bottoms of the plurality of the battery cells, the plurality of the second lower pressure relieving holes being disposed among the plurality of the second lower terminal contacts, when the internal pressures of the plurality of the battery cells are too high, the plurality of the second lower pressure relieving holes releasing the pressures of the plurality of the battery cells.
